(19) United States
(12) Patent Application Publication
(10) Pub. No.: US 2025/0158661 A1
(43) Pub. Date: May 15, 2025

(54) CONTROLLING A RECONFIGURABLE INTELLIGENT SURFACE

(71) Applicant: LENOVO (BEIJING) LIMITED, Beijing (CN)

(72) Inventors: Chenxi Zhu, Fairfax, VA (US); Bingchao Liu, Beijing (CN); Yi Zhang, Beijing (CN)

(21) Appl. No.: 18/723,354

(22) PCT Filed: Dec. 23, 2021
(86) PCT No.: PCT/CN2021/140706

§ 371 Date: Jun. 21, 2024

(51) Int. Cl. H04B 7/04; H04L 25/49

(52) U.S. Cl. CPC H04B 7/04013; H04L 25/4927

(57) ABSTRACT

Apparatuses, methods, and systems are disclosed for controlling a reconfigurable intelligent surface. One method (600) includes determining (602), at a controller, a control signal for a reconfigurable intelligent surface to control a configuration of elements of the reconfigurable intelligent surface. The control signal includes a pair of parameters corresponding to two orthogonal directions. The method (600) includes sending (604) the control signal to the reconfigurable intelligent surface to control the configuration of elements of the reconfigurable intelligent surface.

### FIELD

The subject matter disclosed herein relates generally to wireless communications and more particularly relates to controlling a reconfigurable intelligent surface.

### BACKGROUND

In certain wireless communications networks, a reconfigurable intelligent surface may be used. The reconfigurable intelligent surface may be used in a variety of ways, but may need to be configured properly for use.

### BRIEF SUMMARY

Methods for controlling a reconfigurable intelligent surface are disclosed. Apparatuses and systems also perform the functions of the methods. One embodiment of a method includes determining, at a controller, a control signal for a reconfigurable intelligent surface to control a configuration of elements of the reconfigurable intelligent surface. The control signal includes a pair of parameters corresponding to two orthogonal directions. In some embodiments, the method includes sending the control signal to the reconfigurable intelligent surface to control the configuration of elements of the reconfigurable intelligent surface.

One apparatus for controlling a reconfigurable intelligent surface includes a controller. In some embodiments, the apparatus includes a processor that determines a control signal for a reconfigurable intelligent surface to control a configuration of elements of the reconfigurable intelligent surface. The control signal includes a pair of parameters corresponding to two orthogonal directions. In various embodiments, the apparatus includes a transmitter that sends the control signal to the reconfigurable intelligent surface to control the configuration of elements of the reconfigurable intelligent surface.

Another embodiment of a method for controlling a reconfigurable intelligent surface includes receiving, at a reconfigurable intelligent surface from a controller, a control signal for the reconfigurable intelligent surface to control a configuration of elements of the reconfigurable intelligent surface. The control signal includes a pair of parameters corresponding to two orthogonal directions. In some embodiments, the method includes controlling the configuration of the elements of the reconfigurable intelligent surface.

Another apparatus for controlling a reconfigurable intelligent surface includes a reconfigurable intelligent surface. In some embodiments, the apparatus includes a receiver that receives, from a controller, a control signal for the reconfigurable intelligent surface to control a configuration of elements of the reconfigurable intelligent surface. The control signal includes a pair of parameters corresponding to two orthogonal directions. In various embodiments, the apparatus includes a processor that controls the configuration of the elements of the reconfigurable intelligent surface.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for controlling a reconfigurable intelligent surface;

FIG. 2 is a schematic block diagram illustrating one embodiment of an apparatus that may be used for controlling a reconfigurable intelligent surface;

FIG. 3 is a schematic block diagram illustrating one embodiment of an apparatus that may be used for controlling a reconfigurable intelligent surface;

FIG. 4 is a schematic block diagram illustrating one embodiment of reflection on a RIS surface;

FIG. 5 is a schematic block diagram illustrating another embodiment of reflection on a RIS surface;

FIG. 6 is a flow chart diagram illustrating one embodiment of a method for controlling a reconfigurable intelligent surface; and

FIG. 7 is a flow chart diagram illustrating another embodiment of a method for controlling a reconfigurable intelligent surface.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit.” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java. Smalltalk, C++, or the like, and conventional procedural programming languages, such as the “C” programming language, or the like, and/or machine languages such as assembly languages. The code may execute entirely on the users computer, partly on the users computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising.” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block ofthe schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

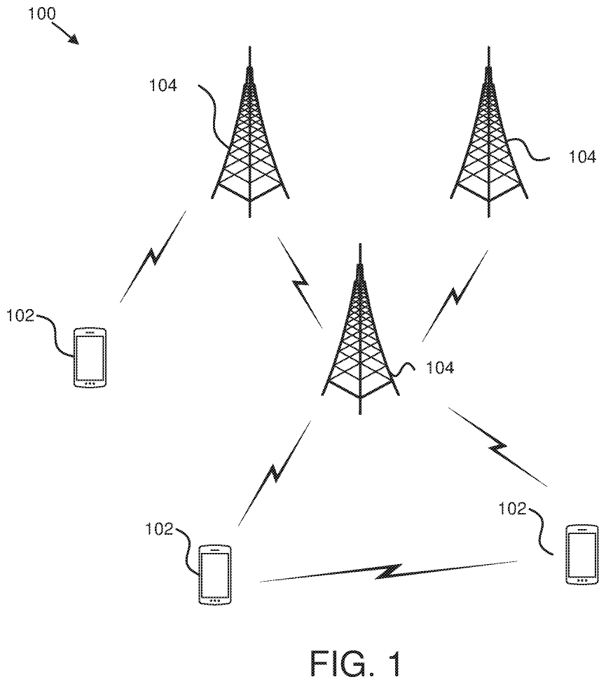

FIG. 1 depicts an embodiment of a wireless communication system 100 for controlling a reconfigurable intelligent surface. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, user equipment (“UE”), user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“cNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), a reconfigurable intelligent surface (“RIS”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 and/or a network unit 104 may determine, at a controller, a control signal for a reconfigurable intelligent surface to control a configuration of elements of the reconfigurable intelligent surface. The control signal includes a pair of parameters corresponding to two orthogonal directions. In some embodiments, the remote unit 102 and/or the network unit 104 may send the control signal to the reconfigurable intelligent surface to control the configuration of elements of the reconfigurable intelligent surface. Accordingly, the remote unit 102 and/or the network unit 104 may be used for controlling a reconfigurable intelligent surface.

In certain embodiments, a network unit 104 (e.g., reconfigurable intelligent surface) may receive, at a reconfigurable intelligent surface from a controller, a control signal for the reconfigurable intelligent surface to control a configuration of elements of the reconfigurable intelligent surface. The control signal includes a pair of parameters corresponding to two orthogonal directions. In some embodiments, the network unit 104 may control the configuration of the elements of the reconfigurable intelligent surface. Accordingly, the network unit 104 may be used for controlling a reconfigurable intelligent surface.

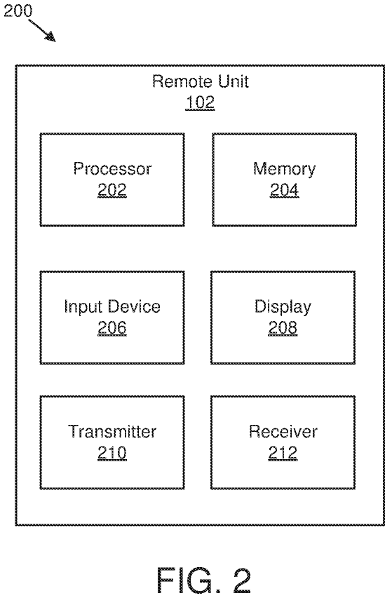

FIG. 2 depicts one embodiment of an apparatus 200 that may be used for controlling a reconfigurable intelligent surface. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 determines a control signal for a reconfigurable intelligent surface to control a configuration of elements of the reconfigurable intelligent surface. The control signal includes a pair of parameters corresponding to two orthogonal directions. In various embodiments, the transmitter 210 sends the control signal to the reconfigurable intelligent surface to control the configuration of elements of the reconfigurable intelligent surface.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

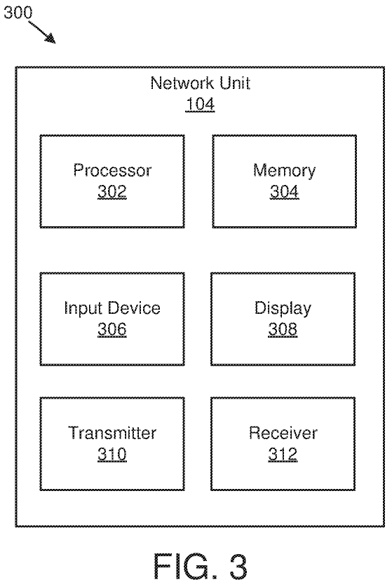

FIG. 3 depicts one embodiment of an apparatus 300 that may be used for controlling a reconfigurable intelligent surface. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 determines a control signal for a reconfigurable intelligent surface to control a configuration of elements of the reconfigurable intelligent surface. The control signal includes a pair of parameters corresponding to two orthogonal directions. In various embodiments, the transmitter 310 sends the control signal to the reconfigurable intelligent surface to control the configuration of elements of the reconfigurable intelligent surface.

In some embodiments, the receiver 312 receives, from a controller, a control signal for the reconfigurable intelligent surface to control a configuration of elements of the reconfigurable intelligent surface. The control signal includes a pair of parameters corresponding to two orthogonal directions. In various embodiments, the processor 302 controls the configuration of the elements of the reconfigurable intelligent surface.

In certain embodiments, a demand for higher data rate and larger capacity (e.g., in a sixth generation (“6G”) system) drives system frequency to a higher frequency. In some embodiments, a 6G system may use mmW and/or a Terahertz band (e.g., 0.1-10 THz). Such embodiments may require new transmitter and/or receiver technologies. Compared with a lower frequency range such as microwave, mmW and/or THz channels may be characterized by directivity, atmospheric absorption, scintillation, scattering, and/or reflection. Moreover, pathloss may be significantly higher than with lower frequencies. Besides free space loss, THz propagation may be plagued by larger atmospheric absorption including H₂O and O₂ molecules. Large pathloss (e.g., including absorption) coupled with low output power may make it necessary to use a large antenna array for a required gain. Massive multiple-input multiple-output (“MIMO”) with hundreds of antenna elements may be used in the mmW range. At mmW or THz range, the antenna array size may continue to increase and go into a range of thousands or more. A large antenna array not only performs the task of spatial power combining from many low power power amplifiers (“PAs”), but also provides strong directional gain required to compensate for the large pathloss and higher spatial resolution. In the THz range, a small scale property of a channel may be dominated by reflection. Channel measurement in the THz range may be reported. Outdoor channel measurements may be reported at 140 gigahertz (“GHz”). Measurement results may show that the channel is mostly composed of distinct line of sight (“LOS”) and non-line of sight (“NLOS”) paths.

In various embodiments, a reconfigurable intelligent surface (“RIS”) (e.g., smart surface (“SS”), large intelligent surface (“LIS”), and/or intelligent reflecting surface (“IRS”)) may be a technology used to play a key role in 6G. A RIS may be a large smart surface placed in a wireless propagation environment as an artificial and programmable reflector to boost a radio signal from a transmitter to a receiver. Moreover, a RIS may have a planar 2 dimensional array of metaatoms (e.g., unit cell, elements) where each passive element (or group of elements) is set to one of several states with different reflecting coefficients. Together they may give the RIS a macro property to manipulate an impinging electromagnetic (“EM”) wave and divert it to a direction of an intended receiver. This may improve performance at a receiver as well as reduce an interference with other users.

In certain embodiments, RIS may be used at a very high frequency range. It should be noted that, as the size of an antenna array increases, a spatial and/or angular resolution of the array improves as dictated by fundamental principle of array signal processing. Due to a sparse channel property, singular modes of a channel between a large transmitter (“TX”) antenna array and a large receiver (“RX”) antenna array includes a set of TX beams (e.g., angle of departures (“AODs”) from the TX side). Different TX beams may be naturally orthogonal and no separate precoder may be needed. For a reflection channel from the TX to the RX through a RIS surface, a reflected beam may be manipulated by a RIS surface in 2 dimensions (e.g., horizontal and vertical). In some embodiments, there may be a structure of a 2D RIS surface, and a scheme to control the RIS surface to achieve a desired reflection.

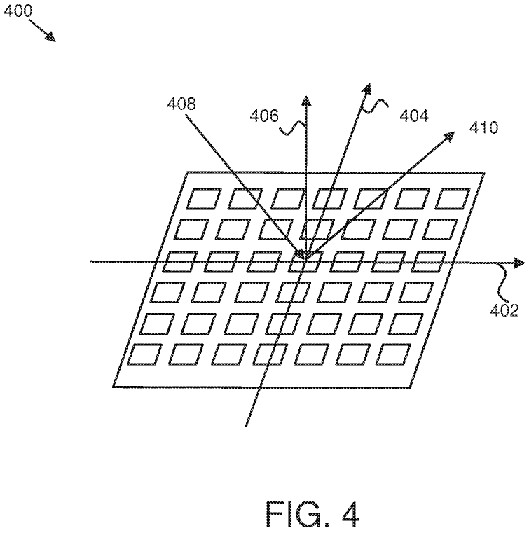

In some embodiments, a RIS surface includes a 2D array of metaatoms (e.g., Nx by Ny). Each of the metaatoms may be programmed. Moreover, the metaatoms are interspaced at dx and dy in the X and Y direction. The reflection coefficient of each metaatom may be either tuned continuously, or the metaatom can be switched to one of several states, each state with its distinct reflection coefficient. Further, the reflection coefficient of the metaatom at the location (m,n) is A_{m,n}e^{jw}^{_{m,n}}. The phase of the metaatoms may be important because a reflection on the RIS surface may be mainly determined by the phase. To reflect the beam from TX in the direction of the RX, the RIS surface needs to control the direction of the reflected beam by controlling the phase of the metaatoms. The details of the reflection, with the definition of incident angle and reflected angle, are shown in FIG. 4.

Specifically, FIG. 4 is a schematic block diagram illustrating one embodiment of reflection on a RIS surface 400. The RIS surface 400 is in an X plane 402 and a Y plane 404, and Z 406 is the normal direction of the RIS surface 400. As an example, X axis is in the horizontal direction, and Y axis is in the vertical direction. The incident beam from a TX 408 is in the direction of (θᵢₙ^{XZ}, θᵢₙ^{YZ}), and a desired reflected beam 410 towards an RX is in the direction of (θₒᵤₜ^{XZ}, θₒᵤₜ^{YZ}). The reflection may be decomposed into two orthogonal direction, one in the XZ plane and the other in the YZ plane. The incident angle (θᵢₙ^{XZ}) and reflected angle (θₒᵤₜ^{XZ}) in the XZ plane are defined in FIG. 4. A diagram in the YZ plane may be similar (e.g., the incident angle (θᵢₙ^{YZ}) and reflected angle (θₒᵤₜ^{YZ}) in the YZ plane).

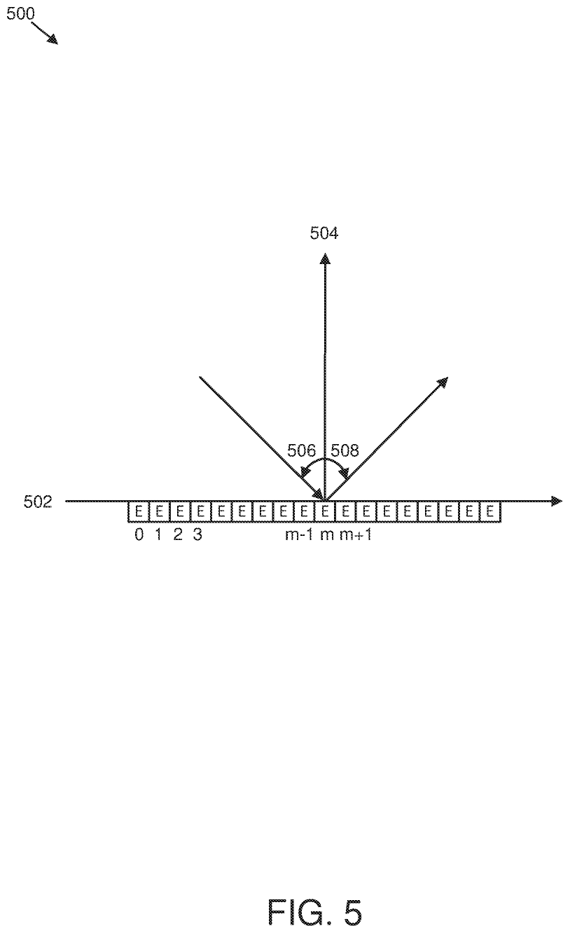

FIG. 5 is a schematic block diagram illustrating another embodiment of reflection on a RIS surface 500 (e.g., in a XZ plane). An X axis 502 and a Z axis 504 are illustrated. The metaatoms (“E”) are labelled in increasing order in the direction of X axis 502.

In order to reflect an incident beam (θᵢₙ^{XZ}) 506 towards a direction of (θₒᵤₜ^{XZ}) 508 in the XZ plane, a phase difference between two adjacent metaatoms in the X direction is given by:

$$Δ {ω}^{X} = {ω}_{m + 1}^{X} - {ω}_{m}^{X} = \frac{2 π {d}_{X}}{λ} ( sin {θ}_{in}^{XZ} - sin {θ}_{out}^{XZ} ) .$$

Further, the gradient of phase change in the X direction

$$( \frac{d {ω}^{X}}{dx} )$$

is given by:

$$\frac{d {ω}^{X}}{dx} = \frac{Δ {ω}^{X}}{{d}_{X}} = \frac{2 π}{λ} ( sin {θ}_{in}^{XZ} - sin {θ}_{out}^{XZ} ) .$$

Similarly, to reflect the incident beam (θᵢₙ^{YZ}) towards the direction of (θₒᵤₜ^{YZ}) in the YZ plane, the phase difference between two adjacent metaatoms in the Y direction is given by:

$$Δ {ω}^{Y} = {ω}_{n + 1}^{Y} - {ω}_{n}^{Y} = \frac{2 π {d}_{Y}}{λ} ( sin {θ}_{in}^{YZ} - sin {θ}_{out}^{Y Z} ) .$$

Moreover, the gradient of phase change in the Y direction

$$( \frac{d {ω}^{Y}}{dy} )$$

is given by:

$$\frac{d {ω}^{Y}}{dy} = \frac{Δ {ω}^{Y}}{{d}_{Y}} = \frac{2 π}{λ} ( sin {θ}_{in}^{Y Z} - sin {θ}_{o u t}^{YZ} ) .$$

In various embodiments, for metaatom element (m, n) in an RIS XY plane, its phase is given by:

$${ω}_{m , n} = m Δ {ω}^{X} + n Δ {ω}^{Y} = \frac{2 π {md}_{X}}{λ} ( sin {θ}_{in}^{XZ} - sin {θ}_{out}^{XZ} ) + \frac{2 π {nd}_{Y}}{λ} ( sin {θ}_{in}^{YZ} - sin {θ}_{out}^{YZ} ) = {md}_{X} \frac{d {ω}^{X}}{dx} + {nd}_{Y} \frac{d {ω}^{Y}}{dy} .$$

In various embodiments, if a phase parameter of the metaatom element (m, n) in an RIS XY plane can only be chosen from a set of given values, a value of the set of given values closest to a determined phase may be applied to the metaatom element (m, n). For example, a determined phase may have any value x between 0 to 2π. If the RIS element can only tuned to one of a few phase values (e.g., {0, π/2, π, 3π/2}), the value closest to x is chosen. In certain embodiments, an effectively a discrete Fourier transform (“DFT”) matrix with different sampling rates in the X and Y direction is applied to the two dimensional (“2D”) RIS surface. (Δω^{X}, Δω^{Y}) may be considered as the sampling rate in the X and Y direction of an oversampled DFT matrix.

In some embodiments, to maximize a received signal strength at a receiver, an RIS may select the strongest beam from the TX and reflect it towards a direction of the strongest beam to the RX. The (θᵢₙ^{XZ}, θᵢₙ^{YZ}) may be chosen to be the angle of arrival (“AOA”) of the strongest beam of the channel from the TX to the RIS, and (θₒᵤₜ^{XZ}, θₒᵤₜ^{YZ}) may be chosen to be the angle of departure (“AOD”) of the strongest beam of the channel from the RIS to the RX. In such embodiments, the effective gain of the cascade channel TX-RIS-RX is maximized, and the received signal to noise ratio (“SNR”) is also maximized.

In various embodiments, a controller on a RIS applies a phase to an element at (m, n). If the phase of the metaatom cannot be tuned continuously but can only be set to a limited set of states Ω={Ω₁, . . . , Ω_{N}}, the state whose phase is closest to ω(m,n) is selected as follows: Ω_{m,n}^{c}=argmin_{Ω}_{ᵢ}_{∈Ω}|ω(Ωᵢ)−ω(m,n)|.

In certain embodiments, a RIS is controlled by a controller. If the controller is separated from the RIS surface (e.g., if the controller is located within a base station), the controller may need to send a control signal to the RIS to control its phase. The control signal may take the form of the phase gradient in the X and Y direction,

$$( \frac{d {ω}^{X}}{dx} , \frac{d {ω}^{Y}}{dy} ) ,$$

or equivalently (Δω^{X}, Δω^{Y}) if it knows interspacing between adjacent metaatoms on the RIS in the X and Y direction. In some embodiments, a quantized version may also be sent. This may avoid sending control information for all individual metaatoms and may reduce signaling overhead. Values may be quantized and sent to a RIS through an interface between the controller and the RIS. The quantization may be done linearly and with a finite number of bits. The finite number of bits may correspond to an index in a predefined table with a set of values. Because a field of view of a RIS may be different in horizontal and vertical directions (e.g., it covers a wider angle in the horizontal direction than the vertical direction), the range covered (e.g., as well as resolution) in these directions may be different too.

In some embodiments, a one dimension linear RIS array (or 2D array controlled by a column) may be considered a special case with only 1 row in the Y direction. In such embodiments, only the parameter

$$( \frac{d {ω}^{X}}{dx} or {Δω}^{X} )$$

is needed to control the RIS surface. Moreover, such embodiments may use quantization described herein.

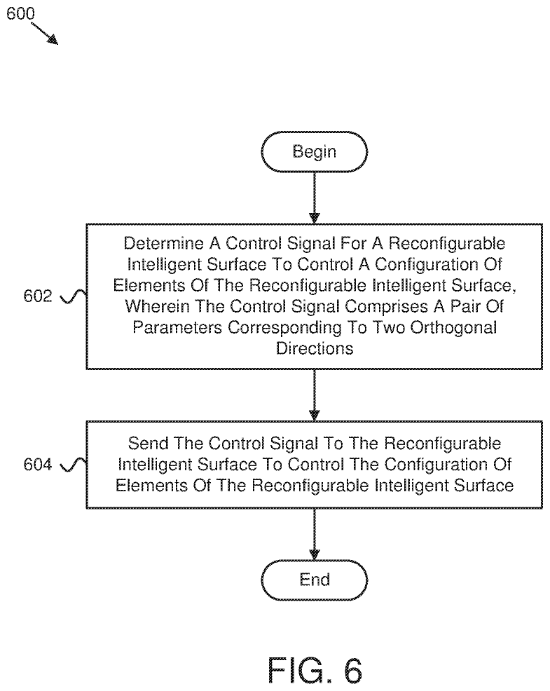

FIG. 6 is a flow chart diagram illustrating one embodiment of a method 600 for controlling a reconfigurable intelligent surface. In some embodiments, the method 600 is performed by an apparatus, such as the remote unit 102 and/or the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes determining 602, at a controller, a control signal for a reconfigurable intelligent surface to control a configuration of elements of the reconfigurable intelligent surface. The control signal includes a pair of parameters corresponding to two orthogonal directions. In some embodiments, the method 600 includes sending 604 the control signal to the reconfigurable intelligent surface to control the configuration of elements of the reconfigurable intelligent surface.

In certain embodiments, a base station comprises the controller. In some embodiments, the control signal is sent as a physical layer signal, as a medium access control message, or as a radio resource control message. In various embodiments, the pair of parameters indicates gradients of a phase of coefficients of reflection in the two orthogonal directions.

In one embodiment, the pair of parameters indicates a phase difference between two adjacent elements in two orthogonal directions. In certain embodiments, the method 600 further comprises quantizing the pair of parameters with a limited number of bits. In some embodiments, the quantizing is a linear quantizing.

In various embodiments, the pair of parameters are given as indices to a predetermined table. In one embodiment, the pair of parameters is determined by an angle of arrival from a transmitter to the reconfigurable intelligent surface, and an angle of departure from the reconfigurable intelligent surface to a receiver.

In certain embodiments, the angle of arrival comprises a direction of a strongest beam from the transmitter to the reconfigurable intelligent surface. In some embodiments, the angle of departure comprises a direction of a strongest beam from the reconfigurable intelligent surface to the receiver.

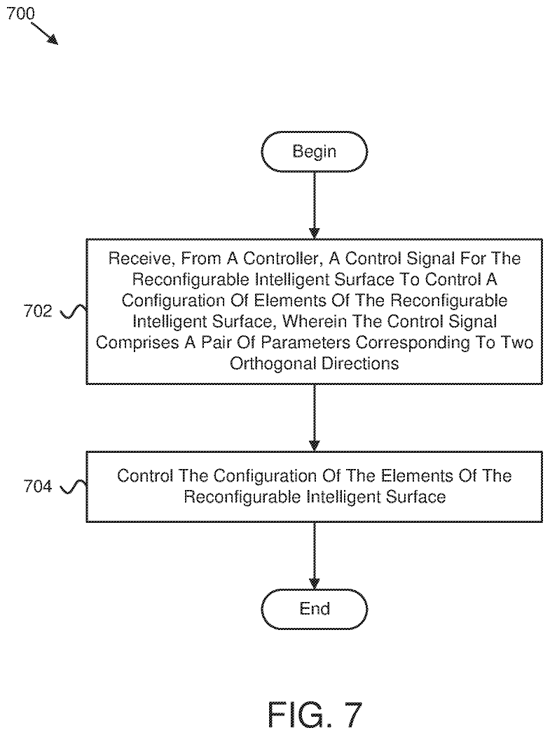

FIG. 7 is a flow chart diagram illustrating another embodiment of a method 700 for controlling a reconfigurable intelligent surface. In some embodiments, the method 700 is performed by an apparatus, such as the network unit 104 and/or a reconfigurable intelligent surface. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, at a reconfigurable intelligent surface from a controller, a control signal for the reconfigurable intelligent surface to control a configuration of elements of the reconfigurable intelligent surface. The control signal includes a pair of parameters corresponding to two orthogonal directions. In some embodiments, the method 700 includes controlling 704 the configuration of the elements of the reconfigurable intelligent surface.

In certain embodiments, a base station comprises the controller and the controller is a network element. In some embodiments, the control signal is received as a physical layer signal, as a medium access control message, or as a radio resource control message. In various embodiments, the pair of parameters indicates gradients of a phase of coefficients of reflection in the two orthogonal directions.

In one embodiment, the pair of parameters indicates a phase difference between two adjacent elements in two orthogonal directions. In certain embodiments, the parameters are quantized with a limited number of bits. In some embodiments, the quantization is a linear quantization.

In various embodiments, the pair of parameters are given as indices to a predetermined table. In one embodiment, the elements of the reconfigurable intelligent surface are arranged as a two-dimensional uniform array, each element of the elements is individually controllable, and each element of the elements is numbered sequentially in each direction of the two orthogonal directions.

In certain embodiments, a phase parameter of an element of the elements of the reconfigurable intelligent surface is determined by a position of the element and a control parameter of the control signal in the two orthogonal directions. In some embodiments, the phase parameter of an element of the elements of the reconfigurable intelligent surface is determined by the sum of the two phase parameters each determined by the position ofthe element and the control parameter of the control signal in each of the two orthogonal directions. In various embodiments, in response to the phase parameter of an element of the elements of the reconfigurable intelligent surface only being able to be chosen from a set of given values, a value of the set of given values closest to the determined sum is applied to the element.

In one embodiment, a method of a controller comprises: determining a control signal for a reconfigurable intelligent surface to control a configuration of elements of the reconfigurable intelligent surface, wherein the control signal comprises a pair of parameters corresponding to two orthogonal directions; and sending the control signal to the reconfigurable intelligent surface to control the configuration of elements of the reconfigurable intelligent surface.

In certain embodiments, a base station comprises the controller.

In some embodiments, the control signal is sent as a physical layer signal, as a medium access control message, or as a radio resource control message.

In various embodiments, the pair of parameters indicates gradients of a phase of coefficients of reflection in the two orthogonal directions.

In one embodiment, the pair of parameters indicates a phase difference between two adjacent elements in two orthogonal directions.

In certain embodiments, the method further comprises quantizing the pair of parameters with a limited number of bits.

In some embodiments, the quantizing is a linear quantizing.

In various embodiments, the pair of parameters are given as indices to a predetermined table.

In one embodiment, the pair of parameters is determined by an angle of arrival from a transmitter to the reconfigurable intelligent surface, and an angle of departure from the reconfigurable intelligent surface to a receiver.

In certain embodiments, the angle of arrival comprises a direction of a strongest beam from the transmitter to the reconfigurable intelligent surface.

In some embodiments, the angle of departure comprises a direction of a strongest beam from the reconfigurable intelligent surface to the receiver.

In one embodiment, an apparatus comprises a controller. The apparatus further comprises: a processor that determines a control signal for a reconfigurable intelligent surface to control a configuration of elements of the reconfigurable intelligent surface, wherein the control signal comprises a pair of parameters corresponding to two orthogonal directions; and a transmitter that sends the control signal to the reconfigurable intelligent surface to control the configuration of elements of the reconfigurable intelligent surface.

In certain embodiments, a base station comprises the controller.

In some embodiments, the control signal is sent as a physical layer signal, as a medium access control message, or as a radio resource control message.

In various embodiments, the pair of parameters indicates gradients of a phase of coefficients of reflection in the two orthogonal directions.

In one embodiment, the pair of parameters indicates a phase difference between two adjacent elements in two orthogonal directions.

In certain embodiments, the processor quantizes the pair of parameters with a limited number of bits.

In some embodiments, the quantizing is a linear quantizing.

In various embodiments, the pair of parameters are given as indices to a predetermined table.

In one embodiment, the pair of parameters is determined by an angle of arrival from a transmitter to the reconfigurable intelligent surface, and an angle of departure from the reconfigurable intelligent surface to a receiver.

In certain embodiments, the angle of arrival comprises a direction of a strongest beam from the transmitter to the reconfigurable intelligent surface.

In some embodiments, the angle of departure comprises a direction of a strongest beam from the reconfigurable intelligent surface to the receiver.

In one embodiment, a method of a reconfigurable intelligent surface comprises: receiving, from a controller, a control signal for the reconfigurable intelligent surface to control a configuration of elements of the reconfigurable intelligent surface, wherein the control signal comprises a pair of parameters corresponding to two orthogonal directions; and controlling the configuration of the elements of the reconfigurable intelligent surface.

In certain embodiments, a base station comprises the controller and the controller is a network element.

In some embodiments, the control signal is received as a physical layer signal, as a medium access control message, or as a radio resource control message.

In various embodiments, the pair of parameters indicates gradients of a phase of coefficients of reflection in the two orthogonal directions.

In one embodiment, the pair of parameters indicates a phase difference between two adjacent elements in two orthogonal directions.

In certain embodiments, the parameters are quantized with a limited number of bits.

In some embodiments, the quantization is a linear quantization.

In various embodiments, the pair of parameters are given as indices to a predetermined table.

In one embodiment, the elements of the reconfigurable intelligent surface are arranged as a two-dimensional uniform array, each element of the elements is individually controllable, and each element of the elements is numbered sequentially in each direction of the two orthogonal directions.

In certain embodiments, a phase parameter of an element of the elements of the reconfigurable intelligent surface is determined by a position of the element and a control parameter of the control signal in the two orthogonal directions.

In some embodiments, the phase parameter of an element of the elements of the reconfigurable intelligent surface is determined by the sum of the two phase parameters each determined by the position of the element and the control parameter of the control signal in each of the two orthogonal directions.

In various embodiments, in response to the phase parameter of an element of the elements of the reconfigurable intelligent surface only being able to be chosen from a set of given values, a value of the set of given values closest to the determined sum is applied to the element.

In one embodiment, an apparatus comprises a reconfigurable intelligent surface. The apparatus further comprises: a receiver that receives, from a controller, a control signal for the reconfigurable intelligent surface to control a configuration of elements of the reconfigurable intelligent surface, wherein the control signal comprises a pair of parameters corresponding to two orthogonal directions; and a processor that controls the configuration of the elements of the reconfigurable intelligent surface.

In certain embodiments, a base station comprises the controller and the controller is a network element.

In some embodiments, the control signal is received as a physical layer signal, as a medium access control message, or as a radio resource control message.

In various embodiments, the pair of parameters indicates gradients of a phase of coefficients of reflection in the two orthogonal directions.

In one embodiment, the pair of parameters indicates a phase difference between two adjacent elements in two orthogonal directions.

In certain embodiments, the parameters are quantized with a limited number of bits.

In some embodiments, the quantization is a linear quantization.

In various embodiments, the pair of parameters are given as indices to a predetermined table.

In one embodiment, the elements of the reconfigurable intelligent surface are arranged as a two-dimensional uniform array, each element of the elements is individually controllable, and each element of the elements is numbered sequentially in each direction of the two orthogonal directions.

In certain embodiments, a phase parameter of an element of the elements of the reconfigurable intelligent surface is determined by a position of the element and a control parameter of the control signal in the two orthogonal directions.

In some embodiments, the phase parameter of an element of the elements of the reconfigurable intelligent surface is determined by the sum of the two phase parameters each determined by the position of the element and the control parameter of the control signal in each of the two orthogonal directions.

In various embodiments, in response to the phase parameter of an element of the elements of the reconfigurable intelligent surface only being able to be chosen from a set of given values, a value of the set of given values closest to the determined sum is applied to the element.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a controller, the method comprising:
determining a control signal for a reconfigurable intelligent surface (RIS) to control a configuration of elements of the RIS, wherein the control signal comprises a pair of parameters corresponding to two orthogonal directions; and
sending the control signal to the RIS to control the configuration of elements of the RIS.

2. A controller, comprising:
at least one memory; and
at least one processor coupled with the at least one memory and configured to cause the controller to:
determine a control signal for a RIS to control a configuration of elements of the RIS, wherein the control signal comprises a pair of parameters corresponding to two orthogonal directions; and
send the control signal to the RIS to control the configuration of elements of the RIS.

3. The controller of claim 2, wherein a base station (B) comprises the controller.

4. The controller of claim 2, wherein the control signal is sent as a physical layer signal, as a medium access control (MAC) message, or as a radio resource control (RRC) message.

5. The controller of claim 2, wherein the pair of parameters indicates gradients of a phase of coefficients of reflection in the two orthogonal directions.

6. The controller of claim 2, wherein the pair of parameters indicates a phase difference between two adjacent elements in two orthogonal directions.

7. The controller of claim 2, wherein the at least one processor is configured to cause the controller to quantize the pair of parameters with a limited number of bits.

8. The controller of claim 7, wherein the quantizing is a linear quantizing.

9. The controller of claim 2, wherein the pair of parameters are given as indices to a predetermined table.

10. The controller of claim 2, wherein the pair of parameters is determined by an angle of arrival from a transmitter to the RIS, and an angle of departure from the RIS to a receiver.

11. The controller of claim 10, wherein the angle of arrival comprises a direction of a strongest beam from the transmitter to the RIS, and the angle of departure comprises a direction of a strongest beam from the RIS to the receiver.

12. A reconfigurable intelligent surface (RIS), comprising:
at least one memory; and
at least one processor coupled with the at least one memory and configured to cause the RIS to:
receive, from a controller, a control signal for the RIS to control a configuration of elements of the RIS, wherein the control signal comprises a pair of parameters corresponding to two orthogonal directions; and
control the configuration of the elements of the RIS.

13. The RIS of claim 12, wherein a phase parameter of an element of the elements of the RIS is determined by a position of the element and a control parameter of the control signal in the two orthogonal directions.

14. The RIS of claim 13, wherein the phase parameter of an element of the elements of the RIS is determined by the sum of the two phase parameters each determined by the position of the element and the control parameter of the control signal in each of the two orthogonal directions.

15. The RIS of claim 14, wherein, in response to the phase parameter of an element of the elements of the RIS only being able to be chosen from a set of given values, a value of the set of given values closest to the determined sum is applied to the element.

16. The method of claim 1, further comprising sending the control signal as a physical layer signal, as a medium access control (MAC) message, or as a radio resource control (RRC) message.

17. A method performed by a reconfigurable intelligent surface (RIS), the method comprising:
receiving, from a controller, a control signal for the RIS to control a configuration of elements of the RIS, wherein the control signal comprises a pair of parameters corresponding to two orthogonal directions; and
controlling the configuration of the elements of the RIS.

18. The method of claim 17, further comprising determining a phase parameter of an element of the elements of the RIS by a position of the element and a control parameter of the control signal in the two orthogonal directions.

19. The method of claim 18, further comprising determining the phase parameter of an element of the elements of the RIS by the sum of the two phase parameters each determined by the position of the element and the control parameter of the control signal in each of the two orthogonal directions.

20. The method of claim 19, further comprising, in response to the phase parameter of an element of the elements of the RIS only being able to be chosen from a set of given values, applying a value of the set of given values closest to the determined sum to the element.
